(19) United States
(12) Patent Application Publication
(10) Pub. No.: US 2006/0206415 A1
(43) Pub. Date: Sep. 14, 2006

(54) Method for facilitating the acquisition of a life insurance policy

(76) Inventor: Mark Ross, New York, NY (US)

Correspondence Address: BRYAN CAVE LLP, 211 NORTH BROADWAY, SUITE 3600, ST. LOUIS, MO, 63102-2750, US

(21) Appl. No.: 11/370,695

(22) Filed: Mar. 8, 2006

Related U.S. Application Data
(60) Provisional application No. 60/659,553, filed on Mar. 8, 2005.

(51) Int. Cl. G06Q 40/00

(52) U.S. Cl. 705/38

(57) ABSTRACT

The invention provides a novel method of facilitating the acquisition of a life insurance policy on the life of an insured. The method involves interaction among a borrower, a lender, a service provider and a collateral agent. Using the inventive method of the present invention, the borrower is able to acquire funds, on an non-recourse basis, from the lender for payment of one or more premiums on the life insurance policy with minimal impact on liquidity. The service provider agrees to provide certain services to the borrower under a service agreement during the term of the service agreement; the borrower's obligations under service agreement are non-recourse. The life insurance policy and its proceeds are held as security for the borrower's obligations to the lender and the service provider by a collateral agent.

### RELATED APPLICATION INFORMATION

This application claims the benefit of U.S. Provisional Patent Application Ser. No. 60/659,553, filed on Mar 8, 2005, the disclosure of which is incorporated herein by reference in its entirety for all purposes.

### FIELD OF THE INVENTION

The present invention relates generally to facilitating the purchase and possible retention of a life insurance policy and, more particularly, to facilitating the purchase and possible retention of a life insurance policy with loans in combination with the provision of services related to the life insurance policy, including but not limited to marketing and related services if the life insurance policy is subsequently offered for sale.

### BACKGROUND OF THE INVENTION

The ability to acquire a life insurance policy insuring the life of an individual is dependent upon a number of factors, one of the most significant of which is the individual's health. The amount of life insurance that can be acquired on an individual's life is also dependent upon a number of factors, including the individual's net worth and/or earning capacity. A relatively healthy individual with significant net worth and/or earning capacity may be eligible to purchase significant life insurance coverage; however, at a particular stage in such individual's life, his or her financial circumstances and liquidity may not permit significant expenditures to acquire life insurance. If the individual's health subsequently declines, the cost of life insurance coverage may increase substantially or life insurance coverage may become unavailable. Thus, there is a need to facilitate the purchase of life insurance on the life of an individual when the individual is relatively healthy, while minimizing the current cash outlay required for such a purchase.

Because such a purchase of a life insurance policy may be implemented to provide the policy owner the option of retaining the policy, there is a need to provide a method for the purchase of a life insurance policy that permits the policy owner to acquire a life insurance policy on a non-recourse basis and in a manner that minimizes the adverse tax consequences to the parties.

### SUMMARY OF THE INVENTION

The present invention is for a method of facilitating the purchase and possible retention of a life insurance policy on the life of an individual, on a non-recourse basis, in a manner that preferably minimizes the risk of adverse tax consequences to the policy owner and provides appropriate financial incentives to the lender and the service provider.

An embodiment of the method of the present invention may preferably involve: (1) a lender, which may be a single entity or individual, or a group of entities and/or individuals associated with one another for purposes of the transaction, (2) a borrower, which may be one or more individuals and/or a trust or other entity, such as a partnership or limited liability company, created by one or more individuals and/or entities, (3) one or more individuals whose lives will be insured by one or more life insurance policies (referred to herein as the insured), and who may also be the borrower; (4) a service provider, which may be the lender or one or more other individuals and/or entities and (5) a collateral agent, which may be the borrower, the lender, the service provider, or one or more other individuals and/or entities.

The borrower acquires one or more policies insuring the life of the insured. Such policy or policies are referred to herein as the life insurance policy. The lender agrees to lend to the borrower funds for payment of some portion, or all, of the premiums due on the life insurance policy. The borrower and the service provider enter into a service agreement, pursuant to which the service provider agrees to provide certain services with respect to the life insurance policy, including but not limited to facilitating a possible sale of the life insurance policy, for a period of time, in exchange for compensation. Where permissible by applicable laws, the service provider may offer additional features to the borrower, such as an optional advance or guaranteed payment. The life insurance policy and its proceeds are held by the collateral agent for the benefit of the lender, the service provider and the borrower, as security for the borrower's obligations to the lender and the service provider.

The borrower's obligations to the lender and the service provider are preferably non-recourse, which means that if the borrower fails to satisfy its obligations to either or both of such parties, the recourse of such party or parties is limited to the rights granted to the collateral agent in the life insurance policy and its proceeds, as security.

Preferably, the borrower will have options for choosing either continued ownership or termination of ownership of the life insurance policy after some period of time has elapsed following receipt of the loan from the lender. One such option may be to pay the lender the amount owed the lender, thereby releasing the life insurance policy from securing the borrower's obligations to the lender; preferably, following the borrower's exercise of such option, the borrower will continue to be obligated to the service provider, and the life insurance policy will continue to secure those obligations, for some period of time following satisfaction of the borrower's obligations to the lender.

Alternatively, the borrower may elect to sell the life insurance policy either to the service provider or a third party. The collateral agent will receive and disburse any policy proceeds received as a result of the insured's death.

Thus, the borrower is able to acquire life insurance on the life of the insured on a non-recourse basis, with minimal impact on liquidity if the borrower does not elect to continue to own the life insurance policy. If the borrower elects to continue to own the life insurance policy because, for example, the borrower has determined that continued life insurance protection on the life of the insured is desirable, the borrower remains obligated to the service provider under the service agreement for a period of time. Following expiration of the term of the service agreement, the borrower will own the life insurance policy, free of any obligation to the service provider or the lender.

Thus, the benefits of the method and system of the invention may include, in addition to others not enumerated below, some or all of the following: (1) initial acquisition of a life insurance policy on a non-recourse basis with minimal impact on the borrower's liquidity; (2) “locking-in” insurability of the insured; (3) financial incentives for the lender and the service provider sufficient to justify the risks of the transaction; (4) mitigation of the risk of adverse Federal income tax consequences to the borrower and the insured; and (5) if the borrower is a properly-drafted irrevocable trust, exclusion of the borrower's share of any proceeds from the sale or surrender of the policy during the insured's lifetime, or of any proceeds payable upon the insured's death, from the estate of the grantor of the trust that is the borrower for Federal estate tax purposes.

### BRIEF DESCRIPTION OF THE FIGURES

These and other features, aspects and advantages of the method of the present invention will become more fully apparent from the following detailed description, appended claims, and accompanying drawings, wherein the drawings illustrate the method in accordance with an exemplary embodiment of the present invention, and wherein:

FIG. 1 is a flow chart depicting the principal steps in phase one of one embodiment of the method of the present invention;

FIG. 2 is a flow chart depicting the principal steps in phase two of one embodiment of the method of the present invention;

FIG. 3 is a flow chart depicting the principal steps in phase three of one embodiment of the method of the present invention; and

FIG. 4 is an example of a term sheet used in one embodiment of the method of the present invention.

### DETAILED DESCRIPTION OF THE INVENTION

The method of the present invention for facilitating the purchase and possible retention of a life insurance policy on a secured, non-recourse basis preferably includes interaction among five principal entities.

A lender will provide the funds to a borrower to enable the borrower to pay one or more premiums on a life insurance policy insuring the life of the insured. The borrower and a service provider will enter into a service agreement pursuant to which the service provider agrees to provide certain services to the borrower with respect to the life insurance policy, including but not limited to services related to a sale of the life insurance policy. A collateral agent will hold assets and/or documents related to the life insurance policy, for the benefit of the lender, the borrower, and the service provider.

The Lender

The lender may be an individual, a single entity, or a group of entities and/or individuals associated with one another for purposes of an embodiment of the method of the present invention.

The Insured

The insured is an individual whose life is insured by the life insurance policy that is the subject of an embodiment of the method of the present invention. It will be understood by one with ordinary skill in the art that a life insurance policy can insure more than one life (for example, a joint or second-to-die policy), and that any such life insurance policy could be used in an embodiment of the method of the present invention. In such case, a reference to the “insured” should be deemed to refer to the insureds, or the survivor of the insureds, as the context may require.

It will be further understood by one with ordinary skill in the art that multiple life insurance policies may be used in an embodiment of the method of the present invention, and that if multiple life insurance policies are the subject of such an embodiment, all life insurance policies may insure the life of the same insured, or some life insurance policies may insure the life of one insured, and other life insurance policies may insure the life of another insured. For example, a single transaction using the method of the present invention may govern policies on the lives of each of a husband and wife.

If more than one life insurance policy is the subject of a single transaction using the method of the present invention, a reference to the life insurance policy shall refer to all, some, or one of such life insurance policies, as the context may require. If the life of more than one individual is insured by such life insurance policies, a reference to the insured shall refer to the individual or individuals whose life or lives are insured by such life insurance policies, as the context may require. Furthermore, in such case, options, rights and obligations of the lender, service provider, borrower and/or collateral agent with respect to the life insurance policy may refer to any one or more of such life insurance policies and such options, rights and/or obligations may be exercised in the same manner or a different manner for such policies.

The Borrower

The borrower may be one or more individuals and/or a trust or other entity, such as a partnership or limited liability company, created by one or more individuals and/or entities. In a preferred embodiment of the method of the present invention, the insured, or another individual or entity, acting alone or with yet another individual or entity, creates a trust or other entity, such as a partnership or limited liability company, which trust or other entity will be the borrower in an embodiment of the method of the present invention. In such preferred embodiment, the trust or other entity that is the borrower is preferably structured to prevent inclusion, for Federal estate tax purposes, of assets owned by the borrower in the estate of any individual who created the borrower. In addition, in the preferred embodiment in which the borrower is a trust, the trust that is the borrower is preferably structured as a “non-grantor trust”; specifically, a trust of which no individual or entity that creates the trust is treated as owner of the trust assets for Federal income tax purposes. Methods of structuring such trusts are known to those with ordinary skill in the art. The borrower may be the insured. If the borrower is not the insured, the borrower will have an insurable interest in the life of the insured under applicable state law.

The Service Provider

The service provider may be the lender. Alternatively, the service provider may be an individual, a single entity, or a group of entities and/or individuals associated with one another for purposes of an embodiment of the method of the present invention.

The Collateral Agent

The collateral agent will hold certain assets and/or documents associated with an embodiment of the method of the present invention for a period of time, as discussed below in more detail. The collateral agent can be an individual, a single entity, or a group of entities and/or individuals associated with one another for purposes of such embodiment. Preferably, the collateral agent is not the borrower, the lender or the service provider. However, any one of the lender, the service provider, or the borrower could be the collateral agent in an embodiment of a method of the present invention.

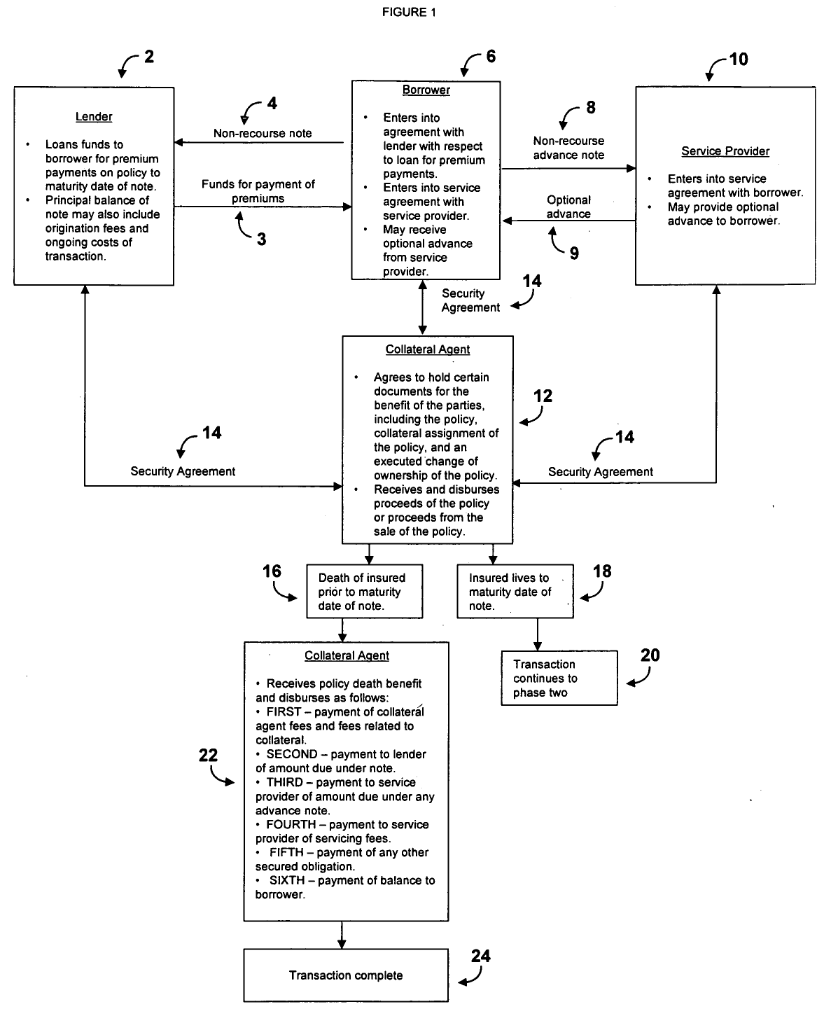

For clarity, and as illustrated in FIGS. 1-3, it is helpful to describe the method of the present invention in three phases. However, it will be understood by one with ordinary skill in the art that separation of the method of the present invention into these phases is for purposes of description only; no formal division into phases is required to practice the method of the present invention.

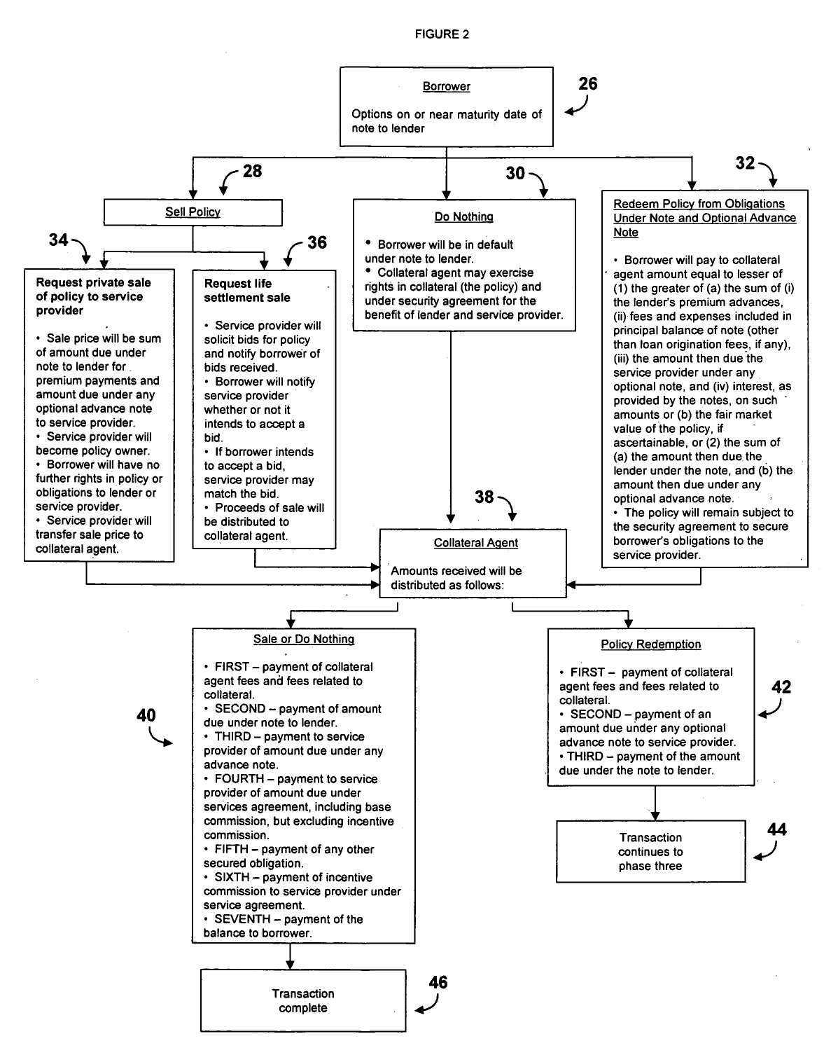

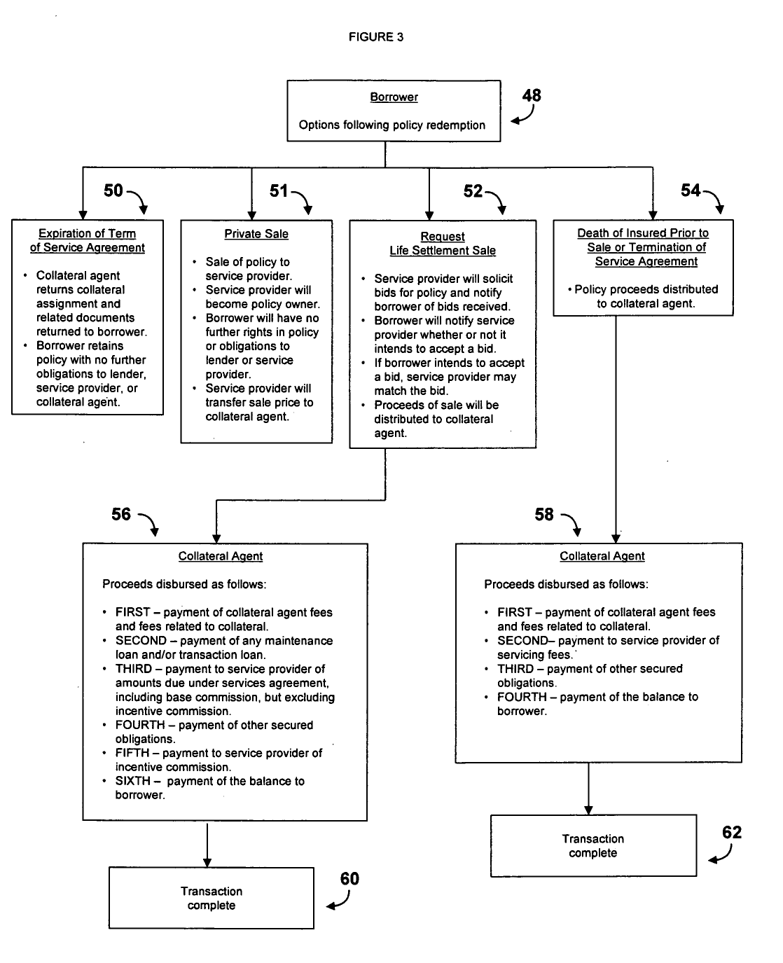

The portion of the method of the present invention described as the first phase FIG. 1 begins generally when the parties enter into one or more agreements to establish their respective rights and obligations with respect to the life insurance policy. This phase continues until on or about the maturity date (as described below) or, if sooner, the death of the insured. The second phase FIG. 2 refers to the period of time near the maturity date. The third phase FIG. 3 refers to the period of time following the maturity date to the expiration of the term of the service agreement (as described below).

Phase One

Acquisition of the Life Insurance Policy. The borrower acquires the life insurance policy. The borrower may acquire the life insurance policy directly from an insurance company. Alternatively, the borrower may acquire the life insurance policy from a previous owner of the life insurance policy by gift, by sale, or by any other method known in the art. The borrower may acquire the life insurance policy directly, such that the borrower is the owner of the policy. Alternatively, the borrower may acquire the policy indirectly, for example, by acquiring an entity or interest in an entity, such as a partnership or limited liability company, that is the owner of the life insurance policy.

Loan from the Lender to the Borrower. The lender loans funds to the borrower, preferably in an amount anticipated to be sufficient to pay premiums on the life insurance policy for a designated period of time, such as to and including the maturity date 2, 3. Such funds may be paid (1) directly by the lender to the insurance company that issued the life insurance policy, (2) to the borrower, subject to an obligation to pay such funds to the insurance company that issued the life insurance policy, and/or (3) to the collateral agent, subject to an obligation to pay such funds to the insurance company that issued the life insurance policy. The loan of the funds for payment of such premiums may be made in one lump sum or periodically, for example, near the due date or dates of premiums for the life insurance policy. In a preferred embodiment of the method of the present invention, the lender will be obligated to make additional loans to the borrower prior to the maturity date if additional premium payments are required (or, in some cases, desirable) with respect to the life insurance policy prior to the maturity date.

Preferably, the borrower has no cash outlay requirements during phase one of the method of the present invention. Therefore, the lender may also loan to the borrower (or may pay directly on behalf of the borrower) other costs and/or fees associated with entering into the loan and/or ongoing costs anticipated with respect to the loan. Such fees and expenses may optionally include (1) fees and expenses incident to the preparation and/or administration of the trust or other entity that is the borrower (if the borrower is not an individual), (2) fees and expenses of the lender relating to its origination of the loan, and/or (3) fees paid or payable to the collateral agent for its services under the security agreement 2. Any such loans may be made in one lump sum or periodically, for example, as payment of such fees and/or expenses come due. In a preferred embodiment of the method of the present invention, the lender will be obligated to make additional loans to the borrower prior to the maturity date if any such fees and/or expenses are due to be paid.

The borrower and the lender will enter into one or more agreements to document their respective rights and obligations with respect to the loans from the lender to the borrower 4, 6. Such agreements, in general, are known in the art and include, but are not limited to notes and/or financing agreements. To practice the method of the present invention, one or more of these agreements (collectively, the “lender financing agreements” and, individually, a “lender financing agreement”) will preferably contain the following provisions:

(1) Establishment of the Principal Amount. The amount loaned and/or to be loaned by the lender to the borrower will be set forth or otherwise described in a manner that permits its calculation by one with ordinary skill in the art; such amount is referred to as the “principal amount of the note”, although the principal amount of the note may be found in a lender financing agreement other than an agreement typically referred to in the art as a note.

(2) Designation of a Maturity Date. A maturity date, which is the date upon which payment of amounts due to the lender under the lender financing agreements is due, will be set forth or otherwise described in a manner that permits its calculation by one with ordinary skill in the art. The maturity date is preferably more than approximately one year but less than approximately five years after the date the borrower and lender enter into one or more of the lender financing agreements; more preferably, the maturity date of the note is between approximately two and approximately three years after the date the borrower and lender enter into one or more of the lender financing agreements. In general, because, as discussed below, the method of the present invention preferably includes an optional sale by the borrower of the life insurance policy, the maturity date preferably will be near or after the date following which the insurance company that issued the life insurance policy can no longer contest payment of the proceeds of the life insurance policy upon the death of the insured and can no longer cancel the life insurance policy, as provided by the contract of insurance and/or applicable law.

A maturity date is preferably included in the method of the present invention to establish a period of time during which the borrower can make a decision and exercise certain options (described below) regarding the on-going ownership of the life insurance policy. It will be understood by one with ordinary skill in the art that means other than establishing a due date for the borrower's payment to the lender of the amounts due to the lender under the could be used to establish such period of time. For example, the borrower's obligations to the lender under the lender financing agreements could be payable on demand of the lender, either at any time, or at any time following one or more designated events and/or following the expiration of a designated period of time; in that case, the maturity date could refer to demand by the lender, occurrence of one or more of the designated events triggering the lender's right to demand payment, and/or expiration of the period of time following which the lender is entitled to demand payment. In general, if the lender financing agreements do not contain a maturity date, as such term is understood by those with ordinary skill in the art, references herein to the maturity date shall refer to the date, dates, and/or period of time during which the borrower can exercise one or more of the options available to the borrower in what is described as phase two of the method of the present invention.

As will be understood by one with ordinary skill in the art, on or prior to the maturity date, the borrower and the lender may agree to extend the maturity date, in which case references to the maturity date shall thereafter refer to the maturity date, as extended.

(3) Provisions for Interest on the Principal Amount. Preferably, interest will be due on the amounts loaned by the lender to the borrower (i.e., on the principal amount of the note). Preferably, any such interest will accrue until the maturity date and will compound at least annually. For example, interest may compound quarterly. Compounding and accruing interest allows the borrower to continue to remain substantially free of obligations of cash outlays at least until the maturity date. In addition, when the borrower is a trust or similar entity, compounding and accruing interest may eliminate the need for gifts, sales or other transfers to the borrower to provide funds that would otherwise be required if interest were to be paid. However, the method of the present invention could be practiced if interest were paid periodically by the borrower.

The borrower and lender may agree on any interest rate; preferably, the interest rate will be approximately equal to the applicable Federal short term rate in effect on the effective date of the note, if the term of the note is three years or less or the note is a demand note, or the applicable Federal mid term rate, if the term of the note is more than three years. An object of the invention is to mitigate the risks of the Internal Revenue Service successfully taking the position that some portion or all of the accrued interest due on the amounts owed by the borrower to the lender is income to the borrower in the event the borrower does not directly repay the amounts due to the lender under the lender financing agreements on the maturity date. Minimizing the interest charged on the principal balance of the note helps to achieve this object.

(4) Establish the Non-Recourse Nature of the Lender Financing Agreements. As described in further detail below, the borrower's obligations to the lender under the lender financing agreements are preferably secured by the life insurance policy, using a collateral assignment document, a security agreement, and/or any other documentation or method known in the art to establish that the life insurance policy secures the borrower's obligations to the lender under the lender financing agreements. Furthermore, the borrower's obligations to the lender under the lender financing agreements are preferably non-recourse; specifically, in the event of the borrower's default under the lender financing agreements, such as the borrower's failure to pay the amounts owed to the lender on the maturity date, the lender's recourse will be limited to the exercise of its rights in the life insurance policy and its proceeds. If the borrower's obligations to the lender under the lender financing agreements are non-recourse, then if the borrower elects not to retain the life insurance policy, the borrower will not be obligated to make any payment to the lender from its assets, other than the life insurance policy; accordingly, the non-recourse nature of the borrower's obligations to the lender helps achieve an object of the invention.

The lender financing agreements may contain terms in addition to those described above, including but not limited to terms related to prepayment of amounts due to the lender by the borrower, governing law, a description of events of default and remedies of the lender upon an event of default. In a preferred embodiment of the invention, events of default include the borrower's failure to pay premiums due on the life insurance policy and/or the borrower's failure to pay the amounts due under the lender financing agreements.

Service Agreement. As discussed above, an object of the method of the present invention is to provide a means of facilitating the acquisition of a life insurance policy in a manner that (1) permits the borrower to acquire the life insurance policy with borrowed funds, on a non-recourse basis, with minimal impact on liquidity, (2) provides the borrower the option of electing not to retain the policy and, upon such election, having no obligations for payment to the lender under the lender financing agreements, and (3) provides appropriate financial incentives to the lender.

A life insurance policy, particularly a life insurance policy with a relatively large face amount of insurance, can require significant time and attention for its proper maintenance and management. For example, in certain life insurance policies, typically called variable or specific account policies, the cash value of the life insurance policy is invested in funds or other investments selected by the owner of the life insurance policy; thus, such a life insurance policy must be managed in a manner similar to other investments. Life insurance policies should typically be evaluated periodically for performance (even if the life insurance policy is not a variable policy), premium due dates must be monitored, and the like.

As discussed above, the borrower's obligations to the lender under the lender financing agreements are preferably non-recourse; therefore, it is important to the lender that the life insurance policy that secures the borrower's obligations to the lender under the lender financing agreements (and that may provide the lender its only source of repayment) is carefully maintained and monitored.

If the borrower determines continued ownership is not appropriate, the borrower and/or the lender may wish to convert the life insurance policy to cash. One means of converting the life insurance policy to cash would be to sell it. Such sales are often referred to by those with ordinary skill in the art, and are referred to herein, as life settlement sales. A life settlement sale of a life insurance policy is distinguished from the surrender of a life insurance policy; a surrender of a life insurance policy involves its return to the insurance company that issued the life insurance policy in exchange for payment by the insurance company of an amount described in the contract of life insurance, which amount is often equal or related to the cash surrender value of the life insurance policy. While a life settlement sale of a life insurance policy may produce a greater return for the life insurance policy than a surrender of that life insurance policy would produce, it is more complicated than a surrender of the life insurance policy; therefore, an agent or broker knowledgeable in the art of such sales is typically engaged to assist with such a sale. Accordingly, the borrower or the lender may have a need for the services of such an agent or broker.

For purposes of information, a life settlement sale is also distinguished by those with ordinary skill in the art from a viatical sale (or viatical settlement)—a viatical sale typically refers to the sale of a life insurance policy to a third party when the insured is reasonably expected to have a significantly shorter than normal life expectancy, for example, a life expectancy of less than two years. As discussed in detail below, the method of the present invention includes an optional life settlement sale. Depending upon the health of the insured at the time of an optional life settlement sale, such sale may be a viatical sale, as such term is used by those with ordinary skill in the art.

The method of the present invention innovatively takes advantage of the needs of the borrower and the lender for services related to the life insurance policy to minimize the risk to the lender, by allocating much of the risk to the service provider. Therefore, a return to the lender based on interest at or near the applicable Federal rate may be acceptable to the lender. The service provider agrees to provide the services that will or may be required with respect to the life insurance policy for a period of time, bears more of the risk associated with the borrower's election regarding retention of the life insurance policy and may (or may not) receive compensation for its services related to the life insurance policy commensurate with the value of those services to the parties and the risk it assumes.

As noted above, in an embodiment of the method of the present invention, the lender can be the service provider. Although the risks discussed above are not shifted from the lender to the service provider in such an embodiment, the method of the present invention does permit an allocation of the compensation to the lender in its respective capacities as lender and service provider in a manner commensurate with its risks and obligations in such respective capacities.

To practice the method of the present invention, the borrower and the service provider will enter into one or more agreements to document their respective rights and obligations with respect to the services to be provided by the service provider to the borrower 6, 10. One or more of these agreements (collectively, the “service agreement”) will preferably contain provisions relating to the following:

(1) Services Provided by Service Provider. The service provider will provide services to the borrower with respect to the life insurance policy, which services may include one or more of the following (a) the administration, servicing and maintenance of the life insurance policy, (b) the performance of refinancing advisory services (e.g., advice regarding insurance financing and refinancing markets), (c) the closing of any optional feature as elected by the borrower, and (d) the performance of any other services other than marketing, soliciting bids for, brokering and selling the life insurance policy.

In addition, the service provider will be designated by the borrower as its broker for any sale of the life insurance policy. Certain preferred provisions relating to the service provider's services as broker for the sale of the life insurance policy are described in more detail below. The service provider may also advise and/or agree to advise the borrower about available premium financing and refinancing, the life settlement market, and related matters.

(2) Compensation to Service Provider. The service agreement will establish compensation for the service provider. In a preferred embodiment of the method of the present invention, the service provider will be entitled to receive compensation if: (a) the life insurance policy is sold while the service agreement is in force, (b) the insured dies while the service agreement is in force, or (c) as more fully discussed below, the collateral agent exercises rights in the life insurance policy and receives proceeds from the exercise of those rights.

Compensation provided to the service provider under the service agreement can be based upon the services provided by the service provider and can be established in any manner that fairly and adequately compensates the service provider for the services it will and/or may provide under the service agreement, taking into consideration the risk to the service provider under the service agreement. In a preferred embodiment of the method of the present invention, the service provider's compensation will include servicing fees, a base commission, and an incentive commission, as more particularly described below:

(i) Servicing Fees. Servicing fees will be owed to the service provider in the event the insured dies during the term of the service agreement, and compensate the service provider for its on-going services related to monitoring the life insurance policy, maintaining the life insurance policy, advising the borrower with respect to options for retention or sale of the life insurance policy, and the like. In a preferred embodiment of the invention, the servicing fees are based upon a percentage of the face amount of the life insurance policy and accrue monthly. In such preferred embodiment of the invention, the aggregate servicing fees will not exceed the base commission (described below) that would have been owed to the service provider if the life insurance policy had been sold prior to the insured's death.

(ii) Base Commission. The service provider will be entitled to receive a base commission if the life insurance policy is sold in a life settlement sale during the term of the service agreement. In a preferred embodiment of the method of the present invention, the base commission is based upon a percentage of the face amount of the life insurance policy.

(iii) Incentive Commission. The service provider may be entitled to receive an incentive commission, if the life insurance policy is sold in a life settlement sale during the term of the service agreement and if the proceeds received in connection with such sale exceed an amount set forth in the service agreement or otherwise described in a manner that permits its calculation by one with ordinary skill in the art. For example, the incentive commission can be a percentage of the portion of the sale proceeds that exceeds the sum of (A) the amounts then due and payable by the borrower to the lender under the lender financing agreements, (B) the base commission due the service provider as a result of the life settlement sale of the life insurance policy, (C) other obligations secured by the life insurance policy, and (D) if the life insurance policy had been the subject of a redemption under the security agreement (as described below), the amounts previously paid by the borrower with respect to such redemption.

(3) Optional Payments by Service Provider to Borrower. Optionally, in a preferred embodiment of the method of the present invention, the borrower may be entitled, where permissible under applicable laws, to receive payments from the service provider that it will be entitled to keep or receive in the event the borrower elects not to retain the life insurance policy.

(i) Optional Advance. One such optional payment that may be used in such a preferred embodiment of the method of the present invention, and where permissible under applicable laws, is a payment of an optional advance from the service provider to the borrower at or near the date upon which the borrower and the service provider enter into the service agreement 9. For example, the borrower may elect to receive the optional advance upon entering into the service agreement, which optional advance will be payable to the borrower by the service provider after expiration of the period of time during which the borrower (or other owner of the life insurance policy) has the right to examine the life insurance policy and cancel the coverage for a refund of the premiums paid with respect to the life insurance policy. In such preferred embodiment of the present invention, if the borrower elects to receive the optional advance, then the base commission and/or the incentive commission to which the service provider is entitled in the event of a life settlement sale of the life insurance policy is preferably greater than the base commission and/or the incentive commission that would have been owed to the service provider if the borrower had not elected to receive the optional advance.

If the borrower receives the optional advance, the borrower and the service provider will preferably enter into one or more agreements to document the borrower's obligation to repay such advance to the service provider, for example, a note 8. Such agreement or agreements (hereinafter referred to as the “advance note”) will preferably contain the following provisions:

(A) Establishment of the Principal Amount. The amount of the optional advance from the service provider to the borrower will be set forth or otherwise described in a manner that permits its calculation by one with ordinary skill in the art; such amount is referred to as the “principal amount of the advance note”.

(B) Provisions for Interest on the Principal Amount. Preferably, interest will be due on the principal amount of the advance note. Preferably, any such interest will accrue until the maturity date and will compound at least annually. For example, interest may compound quarterly.

(C) Establish the Non-Recourse Nature of the Advance Note. As described in further detail below, the borrower's obligations to the service provider, including its obligations under any optional advance note, are preferably secured by the life insurance policy. Furthermore, the borrower's obligations to the service provider, including its obligations under any optional advance note, are preferably non-recourse; specifically, in the event of the borrower's default under the service agreement and/or any optional advance note, the service provider's recourse will be limited to the exercise of its rights in the life insurance policy and its proceeds.

An optional advance note may contain terms in addition to those described above, including but not limited to terms related to prepayment of amounts due to the lender by the borrower, governing law, a description of events of default and remedies of the lender upon an event of default.

Guaranteed Payment Option. An alternative option that may be offered to the borrower in an embodiment of the method of the present invention is a guaranteed payment option; a guaranteed payment refers to a payment the service provider promises to make to the borrower in the event the borrower elects to sell the life insurance policy during the term of the service agreement (as described below).

For example, the borrower may elect the guaranteed payment option at or near the date upon which the borrower and the service provider enter into the service agreement. Consent of the service provider may be required for the borrower's election of the guaranteed payment option. If the borrower elects the guaranteed payment option, then the base commission and/or the incentive commission to which the service provider is entitled in the event of a life settlement sale of the life insurance policy is preferably greater than the base commission and/or the incentive commission that would have been owed to the service provider if the borrower had not elected the guaranteed payment option.

If the borrower elects the guaranteed payment option, the borrower, the service provider and a third party will preferably enter into one or more agreements pursuant to which such third party acts as escrow agent to hold an amount approximately equal to the amount of guaranteed payment. Such agreement or agreements will preferably contain provisions relating to the third party's duties and obligations as escrow agent to hold and manage the funds transferred to it for the benefit of the service provider and the borrower, and provide instructions to such third party for payment of such funds to the service provider and/or the borrower.

(4) Establishment of the Term of the Service Agreement. The service agreement will have a term; following the expiration of such term, the borrower will no longer be obligated to retain the services of the service provider with respect to the life insurance policy, and the service provider will no longer be obligated to provide such services. In a preferred embodiment of the method of the present invention, the term of the service provider will continue until the first to occur of (a) the date upon which the service provider receives the amount to which it is entitled under the service agreement in connection with the death of the insured, (b) the date upon which the service provider receives the amount to which it is entitled under the service agreement in connection with the sale, transfer, or surrender of the life insurance policy, and (c) an expiration date. Preferably, the expiration date is after the maturity date of the borrower's obligations to the lender under the lender financing agreements. More preferably, the expiration date is between approximately one year and approximately five years after such maturity date. For example, the expiration date may be three years after the maturity date of the borrower's obligations to the lender under the lender financing agreements.

In a preferred embodiment of the method of the present invention, the term of the service agreement may be extended if (1) the borrower is in default of its obligations to the service provider upon the expiration of the term, or (2) a life settlement sale is pending. In such case, the term will continue until the borrower is no longer in default or until such sale occurs, as the case may be.

(4) Establish the Non-Recourse Nature of the Borrower's Obligations Under the Service Agreement. As described in further detail below, the borrower's obligations to the service provider under the service agreement are preferably secured by the life insurance policy, using a collateral assignment document, a security agreement, and/or any other documentation or method known in the art to establish that the life insurance policy secures the borrower's obligations to the service provider under the service agreement. Furthermore, the borrower's obligations to the service provider under the service agreement are preferably non-recourse; specifically, the service provider will be entitled to receive its compensation solely from the life insurance policy or its proceeds. In addition, as described in more detail below, if the term of the service agreement ends prior to the death of the insured and prior to a sale of the life insurance policy, then assuming no default by the borrower, the borrower will have no further obligation to the service provider under the service agreement, including no obligation to pay to the service provider the servicing fees or base commission and/or incentive commission to which the service provider would have been entitled if the insured had died or if the life insurance policy had been sold prior to expiration of the term of the service agreement.

Life Insurance Policy Secures Borrower's Obligations. In the method of the present invention, the borrower's obligations to the lender under the lender financing agreements and the borrower's obligations to the service provider under the service agreement (including any obligations of the borrower to the service provider under any optional advance note) are secured by the life insurance policy and its proceeds.

Preferably, a collateral agent will act as an agent to the lender, the service provider, and the borrower to hold the life insurance policy and its proceeds, including any proceeds received as a result of its sale or as a result of the insured's death, for the benefit of the lender, the service provider and/or the borrower 12. The borrower, the lender and/or the service provider will enter into one or more agreements known in the art (for example, a collateral assignment) to create a security interest in the life insurance policy and its proceeds for the benefit of the lender, the service provider and/or the collateral agent, on behalf of the lender and/or the service provider; any such agreements are referred to herein collectively as the “collateral assignment”. In addition, the lender, the service provider, the borrower and the collateral agent will enter into one or more agreements to document their respective rights and obligations with respect to the life insurance policy and its proceeds 14. Examples of such agreements include, but are not limited to security agreements and/or collateral agreements and are referred to herein as the “security agreement”.

Using any appropriate manner known to one with ordinary skill in the art, the security agreement and/or the collateral assignment will preferably contain provisions to: (1) create a security interest in the life insurance policy and its proceeds, which security interest is preferably capable of being perfected in accordance with the applicable state's Uniform Commercial Code; (2) enable the collateral agent to protect and maintain the life insurance policy and its proceeds; and (3) direct the collateral agent regarding the distribution of any proceeds of the life insurance policy received by it.

The security agreement will preferably remain in effect so long as the borrower remains obligated to the lender under the lender financing agreements or to the service provider under the service agreement.

In a preferred embodiment of the method of the present invention, one or more of the lender, the service provider, the borrower and/or the insured will deliver certain documents to the collateral agent, to be held for the benefit of the lender, the service provider, and the borrower in accordance with the terms of the security agreement. These documents may assist the collateral agent in carrying out its duties with respect to the life insurance policy and its proceeds and may aid the lender and/or the service provider in complying with rules and regulations (whether imposed by a governing body, such as a state, or imposed by the insurance company that issued the life insurance policy, as a condition to the issuance and/or continued maintenance of the life insurance policy) that may be applicable to one or more aspects of an embodiment of the method of the present invention. Such documents may optionally include one or more of the following: (1) the original copy of the life insurance policy; (2) a collateral assignment of the life insurance policy, preferably executed by the borrower in favor of the collateral agent; (3) a change of owner form of the life insurance policy, executed by the borrower (or other owner of the life insurance policy); (4) an authorization to release protected health information, executed by the insured, pursuant to which the insured authorizes medical professionals to release medical information regarding the insured to the service provider or its designee for the purpose of evaluating or underwriting the insured's health or life expectancy in connection with the sale of the life insurance policy and to verify such health in connection with the life insurance policy; (5) representations and agreement of the insured (the “insured's representations”) in which the insured (a) acknowledges he or she is the insured under the life insurance policy, (b) acknowledges that the life insurance policy, the lender financing agreements, and the service agreement (including any optional advance note) inure to the insured's benefit, and are being used by the insured for personal planning purposes, (c) represents that he or she does not believe the borrower has a present intent to sell the life insurance policy, and (d) if the borrower is a trust created by the insured, agrees, in order to induce the lender to provide the benefits of the lender financing agreements, (i) that the insured has established the trust that is the borrower for the purpose of obtaining insurance on the insured's life, (ii) that the trust that is the borrower has entered into the lender financing agreements and the service agreement to finance the premiums on the life insurance policy at least until the maturity date, and (iii) that the life insurance policy is collaterally assigned to the collateral agent for the benefit of the lender and the service provider, and that the collateral agent, the lender, and/or the service provider may become the sole owner and beneficiary (or co-owners and co-beneficiaries) of the life insurance policy in the event the borrower defaults under its obligations to the lender under the lender financing agreements and/or to the service provider under the service agreement (including any optional advance note); (6) the insured's designated contacts, with which the insured names certain persons whom the service provider is authorized to contact regarding the insured; (7) an insurability disclosure, with which the insured acknowledges that (a) he or she is the insured under the life insurance policy, (b) that the life insurance policy may be sold at the election of the borrower, (c) if the borrower is a trust, that at the time the life insurance policy was issued, the primary beneficiaries of the trust that is the borrower had an interest in the insured's life, which may include a relationship by blood or marriage, or a substantial economic interest in the insured's continued life, (d) that the lender and the service provider had an interest in the insured's life when the life insurance policy was issued arising from the extension of non-recourse credit for the purchase of the life insurance policy and funds either or both of them will receive if the borrower sells the life insurance policy in a life settlement sale pursuant to the service agreement, (e) that in the event the service provider or another party purchases the life insurance policy, it will acquire ownership and will become the sole beneficiary of any and all benefits and proceeds paid under the life insurance policy upon the insured's death, and (f) that there is a limit on the amount of insurance coverage the insured can obtain on his or her life and the life insurance policy will continue to count toward that limit, as long as the life insurance policy remains in force.

Death of the Insured Prior to Maturity Date. In the event of the death of the insured prior to the maturity date 16, the proceeds of the life insurance policy payable as a result of the death of the insured preferably will be paid to the collateral agent. The collateral agent will receive the proceeds for the benefit of the lender, the service provider and the borrower. Generally, under the method of the present invention, the proceeds of the life insurance policy will be distributed to the collateral agent, the lender, the service provider, and/or the borrower in accordance with the priorities set forth in the security agreement. For example, in a preferred embodiment of the method of the present invention, payment of the proceeds of the life insurance policy in the event of the death of the insured prior to the maturity date will be made as follows: (1) first, to the payment of any unpaid fees due the collateral agent and then to all costs and expenses of and relating to the exercise of any rights and remedies under the security agreement; (2) second, to the payment of the amount then due the lender under the lender financing agreements, i.e., the outstanding principal balance of the note and unpaid accrued interest thereon; (3) third, to the payment of any optional advance note; (4) fourth, to the payment of any unpaid amounts due to the service provider under the service agreement, including the servicing fee; (5) fifth, to the payment of any and all other accrued obligations of the borrower to the lender or the service provider that are secured by the life insurance policy; and (6) sixth, the remainder, if any, to the borrower (or the person, persons, entity and/or entities otherwise entitled to receive the borrower's share of such proceeds) 22.

Policy Contest Prior to Maturity Date. In the event the insurance company that issued the life insurance policy denies a claim for benefits under the life insurance policy or asserts a right to cancel the life insurance policy pursuant to a suicide or contestability provision of the life insurance policy, and, therefore, returns the premiums paid on the life insurance policy, such returned premiums preferably will be paid to the collateral agent. The collateral agent will receive the proceeds for the benefit of the lender and the service provider. Generally, under the method of the present invention, such returned premiums will be distributed to the collateral agent, the lender, the service provider, and/or the borrower in accordance with the priorities set forth in the security agreement. For example, in a preferred embodiment of the method of the present invention, payment of such returned premiums will be made as follows: (1) first, to the payment of any unpaid fees due the collateral agent and then to all costs and expenses of and relating to the exercise of any rights and remedies under the security agreement; (2) second, to the payment of the amount then due the lender under the lender financing agreements, i.e., the outstanding principal balance of the note and unpaid accrued interest thereon; and (3) third, to the payment of any optional advance note.

Phase Two

Phase two describes the period of time near the maturity date of the borrower's obligations to the lender under the lender financing agreements. More generally, it describes the time or times during which the borrower can exercise one or more options with respect to continued ownership of the life insurance policy. For example, in an embodiment of the method of the present invention in which the borrower's obligations to the lender under the lender financing agreements are payable on demand of the lender, either at any time, or at any time following one or more designated events and/or following the expiration of a designated period of time, phase two may describe the period of time near demand by the lender, on or about the occurrence of one or more of the designated events triggering the lender's right to demand payment, and/or near expiration of the period of time following which the lender is entitled to demand payment.

In a preferred embodiment of the method of the present invention for a period of time near the maturity date (for example, for the period of time beginning six months prior to the maturity date and ending on or about the maturity date), the borrower 26 may select among one or more of the following options with respect to the life insurance policy: (1) redeem the life insurance policy, so that it no longer secures the obligations of the borrower to the lender under the lender financing agreements 32, (2) sell the life insurance policy to the service provider for an amount equal to some portion or all of the borrower's liabilities to the collateral agent, to the service provider under any optional advance note, and to the lender under the lender financing agreements 34, or (3) seek to sell the life insurance policy to a third party in a life settlement sale 36. Of course, a borrower may choose to do nothing upon the maturity date 30, which may result in the borrower's default of its obligations to the lender, in which case, as a result of the borrower's default, the collateral agent, acting on behalf of the lender, the service provider, and the borrower, may exercise its rights in the life insurance policy and its proceeds under the security agreement.

Optional Redemption. If the borrower wishes to continue to own the life insurance policy beyond the maturity date, the borrower preferably will have the right to elect to redeem the life insurance policy, so that it no longer secures the obligations of the borrower to the lender under the lender financing agreements. In general, in a preferred embodiment of the method of the present invention, such redemption is structured in a manner that requires repayment to the lender and the service provider of a redemption price approximately equal to any expenditures made by the lender and/or the service provider to or on behalf of the borrower that are secured by the life insurance policy. In addition, a period of time during which the borrower can exercise its right to redeem the life insurance policy—a redemption period—is established. For example, in a preferred embodiment of the method of the present invention in which the amount loaned to the borrower by the lender includes fees and expenses of the lender relating to its origination of the loan, the borrower may be permitted to redeem the life insurance policy during a redemption period on or near the maturity date by paying to the collateral agent a redemption price of an amount equal to the lesser of (1) the greater of (a) the sum of (i) the amounts loaned by the lender to the borrower for premium payments on the life insurance policy included in the principal balance of the note, (ii) amounts loaned by the lender to the borrower for fees and expenses incident to the preparation and/or administration of the trust or entity that is the borrower (if the borrower is not an individual), (iii) fees paid or payable to the collateral agent for its services under the security agreement, (iv) the amount then due under any optional advance note, and (v) interest on the amounts described in (i), (ii), (iii), and (iv), in the amount and as compounded as provided in the lender financing agreements or the advance note, as applicable, or (b) if ascertainable, the fair market value of the life insurance policy, or (2) the aggregate amounts then due to the lender under the lender financing agreements (i.e., the then outstanding principal balance of the note of and any accrued interest thereon) and to the service provider under any optional advance note.

The collateral agent will receive the borrower's payment for redemption of the life insurance policy for the benefit of the lender and the service provider 38. Generally, under the method of the present invention, the proceeds of the borrower's optional redemption of the life insurance policy will be distributed to the collateral agent, the lender, and/or the service provider in accordance with the priorities set forth in the security agreement. For example, in a preferred embodiment of the method of the present invention, payment of the proceeds of the life insurance policy in the event of the redemption of the life insurance policy will be made as follows: (1) first, to the payment of any unpaid fees due the collateral agent and then to all costs and expenses of and relating to the exercise of any rights and remedies under the security agreement; (2) second, to the payment of any optional advance note, and (3) third, to the payment of the amount then due the lender under the lender financing agreements, i.e., the outstanding principal balance of the note and unpaid accrued interest thereon 42. Thereafter, the life insurance policy and its proceeds will no longer be held as security for any obligations of the borrower to the lender under the lender financing agreements. However, the life insurance policy and its proceeds will continue to be held by the collateral agent for the benefit of the service provider, to secure the borrower's obligations to the service provider until expiration of the term of the service agreement.

Optional Sale. Preferably, under the method of the present invention, the borrower will have the right to sell and/or seek to sell the life insurance policy on or near the maturity date. In a preferred embodiment of the present invention, the borrower will have at least two options regarding the sale of the life insurance policy—(1) a right to sell the life insurance policy to the service provider in a private sale during a private sale period for a designated private sale purchase price 34, and (2) a right to solicit bids for the purchase of the life insurance policy in a life settlement sale 36.

Private Sale Option. The borrower's right to sell the life insurance policy to the service provider in a private sale, and the terms and conditions of such sale, can be established in any manner that sets a private sale purchase price approximately equal to the then fair market value of the life insurance policy (or a reasonable approximation thereof), but in no event more than the amount then due by the borrower to the lender under the lender financing agreements. In a preferred embodiment of the method of the present invention, the private sale purchase price for the life insurance policy in the event of a private sale is approximately equal to the sum of (1) amounts loaned to the borrower by the lender for premium payments on the life insurance policy, plus interest on such amounts as provided in the lender financing agreements, and (2) the amount due under any optional advance note to the service provider or the amount of any guaranteed payment, if a guaranteed payment option was offered to and selected by the borrower. A period of time during which the borrower can exercise its right to sell the life insurance policy to the service provider in a private sale—a private sale period—will be set forth or otherwise described in a manner that permits its calculation by one with ordinary skill in the art. For example, in a preferred embodiment of the method of the present invention, the private sale period will begin about six months prior to the maturity date and end on or about the maturity date.

Under a preferred embodiment of the method of the preferred invention, the borrower may optionally have the right to sell the life insurance policy to the service provider in a private sale at one or more other designated times and/or upon the occurrence of one or more other designated events. For example, the borrower may have the right to sell the life insurance policy to the service provider if an expense is incurred or accrued that causes the total amount owed to the service provider to increase by an amount that is greater than a designated percentage (preferably, approximately ten percent) of the total amount owed to the service provider when the borrower and the service provider enter into the service agreement, for a purchase price equal to (1) amounts loaned to the borrower by the lender for premium payments on the life insurance policy, plus interest on such amounts as provided in the lender financing agreements, and (2) the amount due under any optional advance note to the service provider or the amount of any guaranteed payment, if a guaranteed payment option was offered to and selected by the borrower.

The novel private sale option of the method of the present invention helps achieve certain objects of the invention by (1) permitting the borrower to terminate its obligations to the lender and the service provider by selling the life insurance policy to the service provider, thereby ending its ownership of the life insurance policy with minimal impact on its liquidity during its period of ownership, and (2) reducing the risk of the transaction to the lender (as lender, if the lender is the service provider) by providing a market for the life insurance policy in an amount at least equal to the private sale purchase price, i.e., its loans for premium payments on the life insurance policy, plus interest on such loans, as provided in the lender financing agreements.

Following the private sale of the life insurance policy to the service provider, (1) the life insurance policy will be transferred to the service provider as owner, and the service provider can thereafter exercise any and all ownership rights with respect to the life insurance policy, and (2) if a guaranteed payment option was offered to and selected by the borrower, such guaranteed payment will be released by the escrow agent to the borrower 34. In addition, the sale price of the life insurance policy preferably will be paid to the collateral agent 38. The collateral agent will receive the proceeds for the benefit of the lender, the service provider and the borrower. Generally, under the method of the present invention, the proceeds of a private sale of the life insurance policy (the private sale purchase price) will be distributed to the collateral agent, the lender, and/or the service provider in accordance with the priorities set forth in the security agreement. For example, in a preferred embodiment of the method of the present invention, payment of the proceeds of the sale of the life insurance policy to the service provider of a private sale will be made as follows: (1) first, to the payment of any unpaid fees due the collateral agent and then to all costs and expenses of and relating to the exercise of any rights and remedies under the security agreement; (2) second, to the payment of the amount then due the lender under the lender financing agreements, i.e., the outstanding principal balance of the note and unpaid accrued interest thereon; and (3) third, to the payment of any optional advance note 40.

Life Settlement Sale Option. In a preferred embodiment of the method of the present invention, the borrower will have the right on or near the maturity date, and at such other time or times as the borrower and the service provider may agree, to obtain bids for a life settlement sale of the life insurance policy, and the further right and/or obligation to use the services of the service provider in conjunction with obtaining such bids and/or consummating any such sale 36. The service agreement will establish the rights and obligations of the borrower and service provider with respect to soliciting bids for and/or selling the life insurance policy in a life settlement sale. For example, in a preferred embodiment of the method of the present invention: (1) the service provider may be obligated to solicit bids for and market the life insurance policy following receipt by the service provider of the borrower's notice of its intent to seek bids for the life insurance policy; (2) the service provider may be obligated to notify the borrower of all bids it receives for the life insurance policy; (3) the borrower may be obligated to notify the service provider of its intent to accept a bid to purchase the life insurance policy; (4) if the borrower intends to accept a bid, the service provider may have the right to match such bid; (5) the borrower may be obligated, if it accepts any bid, to accept a bid that is the highest bid for the life insurance policy; (6) the borrower may choose to reject all bids; (7) the borrower may be obligated to use its best efforts to cause the insured to cooperate in marketing and selling the life insurance policy, including by the provision of accurate and up-to-date health information; and/or (8) in the event of a transfer or sale of the life insurance policy, the borrower may agree to provide such acknowledgements or representations that may be necessary or desirable under applicable state law, or otherwise desirable, such as (a) an acknowledgement that such transfer or sale will be at a discount from the life insurance policy's face amount, and (b) a waiver of any other alternatives to obtain a value from the life insurance policy, including the right to accelerated benefits or the right to surrender the life insurance policy for its cash value.

In the event of a life settlement sale of the life insurance policy, either to a third party or to the service provider (in the event the service provider had and exercised a right to match the bid the borrower intended to accept), then following the life settlement sale of the life insurance policy, (1) the life insurance policy will be transferred to the purchaser, as owner, and the purchaser can thereafter exercise any and all ownership rights with respect to the life insurance policy, and (2) if a guaranteed payment option was offered to and selected by the borrower, such guaranteed payment will be released by the escrow agent to the borrower. In addition, the sale price of the life insurance policy preferably will be paid to the collateral agent.

The collateral agent will receive the proceeds for the benefit of the lender, the service provider, and the borrower 38. Generally, under the method of the present invention, the proceeds of a private sale of the life insurance policy will be distributed to the collateral agent, the lender, the service provider and/or the borrower in accordance with the priorities set forth in the security agreement. For example, in a preferred embodiment of the method of the present invention, payment of the proceeds of a life settlement sale of the life insurance policy will be made as follows: (1) first, to the payment of any unpaid fees due the collateral agent and then to all costs and expenses of and relating to the exercise of any rights and remedies under the security agreement; (2) second, to the payment of the amount then due the lender under the lender financing agreements, i.e., the outstanding principal balance of the note and unpaid accrued interest thereon; (3) third, to the payment of any optional advance note; (4) fourth, to the payment of any unpaid amounts due to the service provider under the service agreement, including the base commission, but excluding the incentive commission; (5) fifth, to the payment of any and all other accrued obligations of the borrower to the lender or the service provider that are secured by the life insurance policy; (6) sixth, the to the payment to the service provider of any incentive commission owed to the service provider under the service agreement; and (7) seventh, the remainder, if any, to the borrower (or the person, persons, entity and/or entities otherwise entitled to receive the borrower's share of such proceeds) 40.

No Action. The borrower may also choose not to take any action on or near the maturity date, in which case the borrower will ultimately be in default of its obligations to the lender under the lender financing agreements 30 and, therefore, the collateral agent may exercise its rights in the life insurance policy and its proceeds for the benefit of the lender, the service provider and/or the borrower, including but not limited to its right to sell the life insurance policy. Preferably, in the event the collateral agent elects to sell the life insurance policy as a result of the borrower's default, the service provider will serve as the exclusive broker to market and sell the life insurance policy and, in such event, will be entitled to receive as compensation for its services the base commission and the incentive commission, described above.

The collateral agent will receive the proceeds resulting from its exercise of its rights in the life insurance policy for the benefit of the lender, the service provider and/or the borrower 38. Generally, under the method of the present invention, such proceeds will be distributed to the collateral agent, the lender, the service provider and/or the borrower in accordance with the priorities set forth in the security agreement. For example, in a preferred embodiment of the method of the present invention, payment of the proceeds resulting from the collateral agent's exercise of its rights in the life insurance policy will be made as follows: (1) first, to the payment of any unpaid fees due the collateral agent and then to all costs and expenses of and relating to the exercise of any rights and remedies under the security agreement; (2) second, to the payment of the amount then due the lender under the lender financing agreements, i.e., the outstanding principal balance of the note and unpaid accrued interest thereon; (3) third, to the payment of any optional advance note; (4) fourth, to the payment of any unpaid amounts due to the service provider under the service agreement, including the base commission, but excluding the incentive commission; (5) fifth, to the payment of any and all other accrued obligations of the borrower to the lender or the service provider that are secured by the life insurance policy; (6) sixth, the to the payment to the service provider of any incentive commission owed to the service provider; and (7) seventh, the remainder, if any, to the borrower (or the person or entity otherwise entitled to receive the borrower's share of such proceeds) 40.

Phase Three

Phase three is used to describe the period of time following the maturity date, if the borrower elects to redeem the life insurance policy as described above. Phase three will continue until expiration of the term of the service agreement.

Borrower's Obligations for Premiums and Expenses. If the borrower elects to redeem the life insurance policy, as described above, then unless the parties agree otherwise, the borrower will be responsible for payment of any premiums on the life insurance policy due following redemption of the life insurance policy.

Optionally, if additional premiums, adjustments to premiums, or other required payments come due with respect to a life insurance policy following redemption of the life insurance policy by the borrower, the service provider may pay such premiums and, in such event, such payments (referred to herein as a “maintenance loan”) will be deemed added to the obligations of the borrower to the service provider under the service agreement, will be treated as an additional deemed loan from the service provider to the borrower, and interest will accrue on such payments at a rate and at such provisions for compounding as the borrower and the service provider may agree.

In addition, under the method of the present invention, the service provider may pay, on behalf of the borrower, additional trust administration and maintenance fees (if the borrower is a trust) and/or fees due the collateral agent under the security agreement and, in such event, such payments (referred to herein as a “transaction loan”) will be deemed added to the obligations of the borrower to the service provider under the service agreement, will be treated as an additional deemed loan from the service provider to the borrower, and interest will accrue on such payments at a rate and at such provisions for compounding as the borrower and the service provider may agree.

Optional Sale of Life Insurance Policy. In a preferred embodiment of the method of the present invention, following the redemption of the life insurance policy, then until the expiration of the term of the service agreement, the borrower 48 will (1) have the right to offer to sell the life insurance policy to the service provider for such price and on such terms and conditions as the borrower and the service provider may agree 51, and/or (2) have the right to obtain bids for a life settlement sale of the life insurance policy, and the further right and/or obligation to use the services of the service provider in conjunction with obtaining such bids and/or effecting any such sale 52, in the manner described above.

In the event the life insurance policy is sold in a private sale or a life settlement sale following redemption of the life insurance policy, but prior to expiration of the term of the service agreement, the sale price of the life insurance policy preferably will be paid to the collateral agent 56. The collateral agent will receive the proceeds for the benefit of the service provider and the borrower. Generally, under the method of the present invention, the proceeds of such a sale of the life insurance policy will be distributed to the collateral agent, the service provider and/or the borrower in accordance with the priorities set forth in the security agreement. For example, in a preferred embodiment of the method of the present invention, payment of the proceeds of the life insurance policy received in such a sale of the life insurance policy will be made: (1) first, to the payment of any unpaid fees due the collateral agent and then to all costs and expenses of and relating to the exercise of any rights and remedies under the security agreement; (2) second, to the payment of any maintenance loan and/or any transaction loan; (3) third, to the payment of any unpaid amounts due to the service provider under the service agreement, including the base commission, but excluding the incentive commission; (4) fourth, to the payment of any and all other accrued obligations of the borrower to the service provider that are secured by the life insurance policy; (5) fifth, the to the payment to the service provider of any incentive commission owed to the service provider under the service agreement; and (6) sixth, the remainder, if any, to the borrower (or the person, persons, entity or entities otherwise entitled to receive the borrower's share of such proceeds) 56.

Death of the Insured. In the event the insured dies prior to expiration of the term of the security agreement 54, the proceeds of the life insurance policy paid as a result of the death of the insured preferably will be paid to the collateral agent 58. The collateral agent will receive the proceeds for the benefit of the service provider and the borrower. Generally, under the method of the present invention, the proceeds received as a result of the death of the insured following redemption of the life insurance policy will be distributed to the collateral agent, the service provider and/or the borrower in accordance with the priorities set forth in the security agreement. For example, in a preferred embodiment of the method of the present invention, payment of such proceeds of the life insurance policy may be made as follows: (1) first, to the payment of any unpaid fees due the collateral agent and then to all costs and expenses of and relating to the exercise of any rights and remedies under the security agreement; (2) second, to the payment of any maintenance loan and/or any transaction loan; (3) third, to the payment of any unpaid amounts due to the service provider under the service agreement, including the servicing fee; (4) fourth, to the payment of any and all other accrued obligations of the borrower to the lender or the service provider that are secured by the life insurance policy; and (5) fifth, the remainder, if any, to the borrower (or the person or entity otherwise entitled to receive the borrower's share of such proceeds) 58.

Expiration of Term of Service Agreement. Following the expiration of the term of the service agreement, under the method of the present invention, the collateral agent will release the life insurance policy to the borrower, and the borrower will thereafter hold the life insurance policy free and clear of any rights or obligations to the lender under the lender financing agreement, to the service provider under the service agreement (including any optional advance note), and/or to the collateral agent under the security agreement 50.

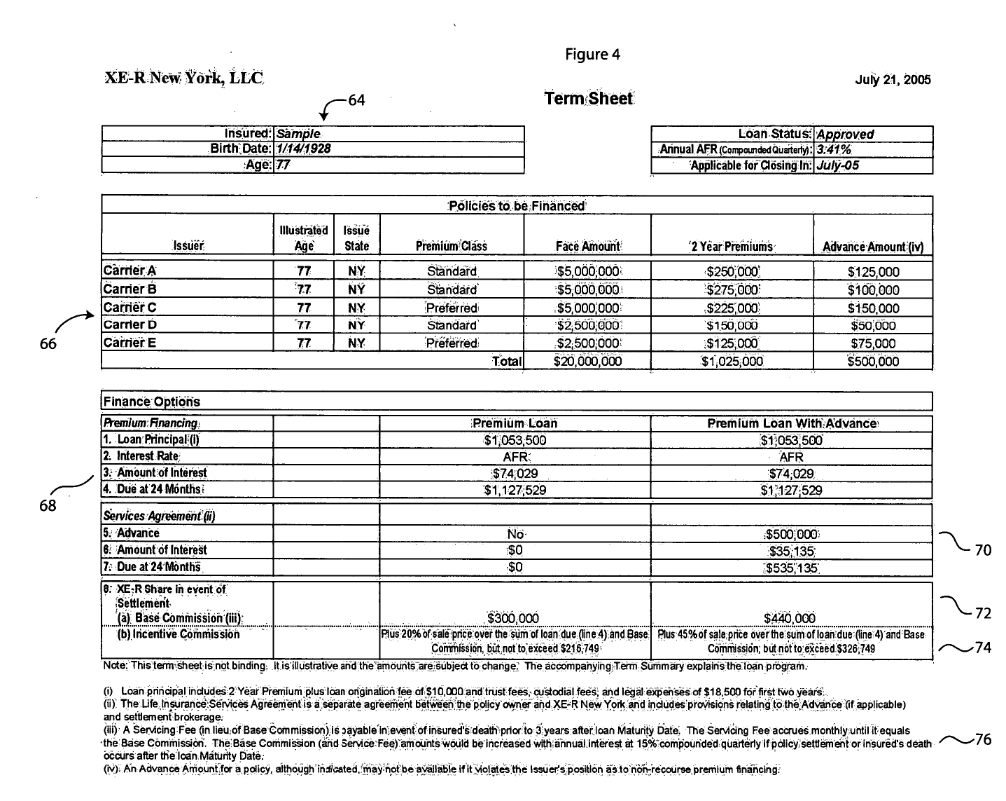

FIG. 4 is an example of a term sheet that might be provided to a borrower practicing an embodiment of the method of the present invention. The term sheet names the insured 64 and lists the life insurance policies 66 that will be used in an embodiment of the method of the present invention. The term sheet describes amounts due by the borrower to the lender under the lender financing agreements 68. The term sheet lists an optional advance, to be paid by the service provider to the borrower 70, and describes the base commission 72 and incentive commission 74 or the servicing fee 76 to which the service provider may be entitled.

Use of Computers

Computers may be used in one or more embodiments of the method of the present invention, in a variety of capacities. For example, a computer may be used to calculate the amount of premium anticipated to be due on the life insurance policy through the maturity date. The service provider may use a computer to calculate the amount of an optional advance to the borrower. The amount due the lender by the borrower under the lender financing agreements can be calculated using a computer. The private sale purchase price and/or the redemption price can be calculated using a computer. The servicing fee, base commission, and/or incentive commission can be calculated using a computer. In general, it will be understood by one with ordinary skill in the art that computers can be used to perform any one or more of the calculations described herein when practicing an embodiment of the method of the present invention.

What is claimed is:

1. A method of facilitating the purchase of a life insurance policy by a borrower, the method comprising:
acquiring a life insurance policy on the life of an insured, said acquisition comprising payment of a premium for said life insurance policy;
receiving a loan of a principal amount from a lender, wherein said principal amount is greater than or approximately equal to the amount of said premium;
executing a non-recourse note for said principal amount in favor of said lender;
entering into a service agreement with a service provider, said service agreement comprising a term, wherein said service provider agrees to purchase said life insurance policy in a private sale during a private sale period for a private sale purchase price and wherein said borrower agrees said service provider shall be entitled to receive a servicing fee if said insured dies during said term; and
entering into a security agreement with a collateral agent, said lender and said service provider, wherein said collateral agent agrees to hold said life insurance policy and any proceeds of said life insurance policy as security for said borrower's obligations to said lender under said non-recourse note and for said borrower's obligations to said service provider under said service agreement, and wherein said borrower, said lender, service provider and said collateral agent agree said borrower shall be entitled to redeem said life insurance policy during a redemption period for a redemption price.

2. The method of claim 1, wherein said non-recourse note further comprises a maturity date and provisions for accrual of interest on said principal amount at an interest rate to said maturity date.

3. The method of claim 2, wherein said security agreement further comprises an expiration date that is after said maturity date of said non-recourse note.

4. The method of claim 3 wherein said non-recourse note further comprises an effective date and wherein said maturity date of said non-recourse note is between approximately two years and approximately three years after said effective date.

6. The method of claim 4 wherein said expiration date of said service agreement is between approximately fours years and approximately six years after said effective date of said note.

7. The method of claim 1, wherein said borrower is a trust having assets created by a grantor.

8. The method of claim 7 wherein said grantor will not be treated as owner of any of said assets of said trust for income tax purposes.

9. The method of claim 1, said method further comprising
redeeming said life insurance policy by paying to said collateral agent the redemption amount.

10. The method of claim 1, said method further comprising
selling said life insurance policy to said service provider in a private sale for the private sale purchase price.

11. The method of claim 1, wherein said borrower agrees in said service agreement that said service provider shall be entitled to receive a base commission if said life insurance policy is sold in a life settlement sale during said term of said service agreement.

12. The method of claim 11, said method further comprising
receiving a bid from a purchaser for the life settlement sale of said life insurance policy at a purchase price;
accepting said bid; and
selling said life insurance policy to said purchaser for said purchase price.

13. A method of facilitating the purchase of a life insurance policy by a lender, the method comprising:
lending to a borrower, said borrower having acquired a life insurance policy on the life of an insured wherein said acquisition comprises payment of a premium for said life insurance policy, a loan of a principal amount, wherein said principal amount is greater than or approximately equal to the amount of said premium;
receiving from said borrower an executed non-recourse note for said principal amount in favor of said lender, said non-recourse note comprising a maturity date and provisions for accrual of interest on said principal amount at an interest rate to said maturity date;
facilitating a service agreement between said borrower and a service provider, said service agreement comprising a term, wherein said service provider agrees to purchase said life insurance policy in a private sale during a private sale term for a private sale purchase price, wherein said borrower agrees said service provider shall be entitled to receive a base commission if said life insurance policy is sold in a life settlement sale during said term, and wherein said borrower agrees said service provider shall be entitled to receive a servicing fee if said insured dies during said term; and
entering into a security agreement with a collateral agent, said borrower and said service provider, wherein said collateral agent agrees to hold said life insurance policy and any proceeds of said life insurance policy as security for said borrower's obligations to said lender under said non-recourse note and for said borrower's obligations to said service provider under said service agreement, and wherein said borrower, said lender, service provider and said collateral agent agree said borrower shall be entitled to redeem said life insurance policy during a redemption period for a redemption price.
